(19) United States
(12) Patent Application Publication
(10) Pub. No.: US 2025/0342820 A1
(43) Pub. Date: Nov. 6, 2025

(54) SYSTEMS AND METHODS FOR GENERATING SYNTHETIC DATA, AND TRAINING AND TESTING CONVERSATIONAL ARTIFICIAL INTELLIGENCE PLATFORMS

(71) Applicant: Sestek Ses ve Iletisim Bilgisayar Teknolojileri San. ve Tic. A.S., Istanbul (TR)

(72) Inventors: Levent ARSLAN, Istanbul (TR); Bayram BOYRAZ, London (GB); Betul UYSAL, Istanbul (TR); Murat ILKDOGAN, Haarlem (NL); Tuba ARSLAN KIR, Istanbul (TR); Cagatay YURDASAL, Istanbul (TR)

(73) Assignee: Sestek Ses ve Iletisim Bilgisayar Teknolojileri San. ve Tic. A.S., Istanbul (TR)

(21) Appl. No.: 18/654,019

(22) Filed: May 3, 2024

(51) Int. Cl. G10L 13/08; G10L 15/06; G10L 15/07; G10L 15/16

(52) U.S. Cl. CPC G10L 13/08; G10L 15/063; G10L 15/07; G10L 15/16; G10L 2015/0636

(57) ABSTRACT

Methods and systems for generating and employing synthetic data are disclosed. The synthetic data is generated by defining roles for a plurality of speakers and inputting the roles to at least one Large Language Model (LLM), which in turn successively generates statements of each speaker which are responsive to generated statements for the other speaker based on the defined roles. Each successive set of statements are input to the LLM to generate additional statements of the speakers to obtain synthetic dialog data. The synthetic dialog data can be used to test and/or train neural networks as well as various platforms, including conversation analytics platforms.

### TECHNICAL FIELD

The present disclosure relates to conversational artificial intelligence platforms and, in particular, to generating synthetic data to train and test conversational artificial intelligence platforms.

### BACKGROUND

Recent advancement in Large Language Models (LLMs) have revealed the potential of human-like interaction for various application areas. Data is in the center of a world surrounded by human-machine interaction to engage with various services as the primary contact points. High-caliber data holds vast promise, driving informed decision-making and shaping the trajectories of businesses, institutions, and communities. When it comes to data collection, it is not always possible to collect data due to various reasons such as sensitivity and expenses of the process. Synthetic data may overtake real data, as it replicates the traits and behavior of real data. This artificial data has the potential to train, test and validate genuine systems like chatbots and virtual agents, particularly in industries where user interaction is crucial.

More than 60% of data collectors' time is spent on data collection, structuring, and cleaning data instead of actual analysis and training. This issue becomes more complex when there is a requirement to handle sensitive or confidential data, such as medical records and credit card information.

Traditional methodologies predominantly revolve around real conversational data or simple intent recognition datasets, which present significant challenges and limitations in the development and evaluation of conversational systems. One of the paramount issues with using real conversational data is the inherent privacy and consent concerns. Real dialogues often contain personal, sensitive information that cannot be ethically or legally used without rigorous anonymization processes, which can be complex and not always entirely foolproof. Moreover, the authenticity and richness of the conversation can be compromised during the anonymization process, leading to less effective testing and demonstration data. Furthermore, real-world data is limited by its contextual scope and diversity. It reflects only the scenarios in which it was captured, thereby constraining the range of interactions a conversational system can be tested against. This limitation is particularly critical in a testing environment, where the objective is to evaluate the system's adaptability and responsiveness to a broad spectrum of conversational contexts and dynamics. The process of collecting and curating real conversational data is also fraught with challenges. It's often time-consuming, resource-intensive, and subject to the availability and willingness of participants. The scalability of data collection is another concern, especially when specific, niche scenarios are required for targeted testing and demonstrations.

Currently, the simulated conversational data landscape primarily centers around challenges related to intent recognition which is an important component for understanding and responding to user requests effectively. The generation of intent recognition data involves creating mappings between user inputs and predefined intents, allowing conversational artificial intelligence (AI) technologies to categorize and respond to queries based on the identified intent. This approach has been instrumental in developing AI applications capable of executing specific tasks or providing information in response to direct user requests. However, this focus on intent recognition data generation comes with significant limitations, particularly when it comes to replicating the dynamics of human conversation. One of the primary shortcomings is the lack of contextual and conversational depth in the generated data. Since the data is tailored towards identifying discrete intents, it often lacks the continuity and richness inherent in natural dialogues. Human conversations are characterized by flow and context, where each exchange builds upon the previous, weaving a tapestry of shared understanding and nuance. Intent recognition data, by its nature, is unable to capture this complexity, as it is structured around isolated instances of interaction rather than continuous dialogue. Moreover, the generation of intent recognition data does not account for the variability and unpredictability present in real-life conversations. Human dialogues can veer in unexpected directions, encompass a wide range of topics, and involve various conversational cues and subtleties. Traditional methods of generating intent recognition data do not adequately simulate these aspects, leading to AI systems that, while effective in understanding specific requests, are ill-equipped to handle the multifaceted nature of human communication. Moreover, the generation of intent recognition data does not account for the variability and unpredictability present in real-life conversations. Human dialogues can veer in unexpected directions, encompass a wide range of topics, and involve various conversational cues and subtleties. Traditional methods of generating intent recognition data do not adequately simulate these aspects, leading to AI systems that, while effective in understanding specific requests, are ill-equipped to handle the multifaceted nature of human communication. The limitations of existing technologies in generating comprehensive conversational data result in significant challenges for AI systems' testing and demonstration capabilities. Without access to rich, context-aware dialogues that mirror the complexities of human interaction, these systems remain constrained in their ability to engage in realistic conversations.

Existing technologies predominantly focused on understanding the user's intent from isolated inputs without engaging in a dynamic, multi-turn conversation that mirrors human interactions. This limitation stemmed from the inherent design of these systems, which prioritized direct responses to user inputs over the continuation of a contextually rich conversation. Consequently, while these systems could recognize specific intents and provide corresponding responses, they fell short in simulating the back-and-forth nature of genuine human dialogues, important for applications requiring more sophisticated conversational capabilities, such as virtual customer service agents, interactive storytelling, and complex problem-solving scenarios.

Other traditional methods and technologies in this space typically involve the use of predefined templates or rule-based systems to simulate conversations to generate conversational data. These systems, while useful in structured domains with limited variability, struggle to capture the depth and nuance of human conversations. The generated interactions often lacked the fluidity and adaptability inherent in natural human dialogues, resulting in a robotic and sometimes disjointed user experience. This shortfall in capturing conversational continuity and depth was further exacerbated by the static nature of the template and rule-based approaches, which could not easily adapt to the evolving context of a conversation or the unique linguistic nuances of individual users. These systems were often unable to handle the subtleties of language such as irony, humor, or cultural references, elements that are quintessential to human communication. Additionally, the reliance on predefined responses limited the ability of these systems to learn from interactions, preventing any significant improvement in conversational quality over time. The consequence was a gap between the expectations of users seeking natural, engaging conversations and the capabilities of AI-driven systems, which were constrained by the limitations of their underlying technology. Furthermore, the lack of personalized and context-aware conversational data in traditional systems meant that these interactions often felt impersonal and generic, lacking the bespoke touch that can significantly enhance user experience. Without the ability to generate and utilize rich, dynamic conversational datasets, these systems were ill-equipped to simulate the kind of personalized and adaptive dialogues that characterize human interactions.

Some academic research methods propose a solution for this problem using LLMs, but they also come with limitations when it comes to domain specific, complex data generation. An example of the current academic method for generating synthetic dialogues is aimed at training conversational agents to assist users in formulating linear programming (LP) models from textual descriptions. This method utilizes a dual-agent setup with two LLMs simulating a conversation between a user and an assistant. The first agent, the Question Generation (QG) Agent, is tasked with eliciting key information from the problem statement by asking questions. The second, the Question Answering (QA) Agent, responds based on a predefined problem statement from the NL4Opt dataset, simulating a user knowledgeable about the problem. This setup is designed to generate dialogues that extract essential information for LP model formulation. An important component of the QA Agent includes a mechanism leveraging LLMs to compare generated summaries with original problem statements, providing feedback on discrepancies and indicating when the dialogue generation should conclude. The system employs prompts throughout the dialogue to maintain consistency and guide the LLMs' responses. The development of the dialogues is based on problem descriptions from the NL4Opt dataset, with the aim of creating a diverse set of dialogues for robust model training and evaluation. Despite these advancements, the method may encounter limitations when dealing with complex or nuanced LP problems that require a deeper understanding or are not well-represented in the training data. Such challenges could lead to inaccuracies in the generated LP models or necessitate further human intervention to refine the models. Moreover, the method's structured approach to simulating a conversation between a user and an assistant-centered around LP problem-solving-may not fully encapsulate the dynamic and contextually rich nature of human interactions. Real conversations often involve fluid topic transitions, the management of ambiguities, and the need for clarifications, aspects that may not be adequately addressed by a system primarily designed to elicit and respond to specific information.

Another notable limitation of these current approaches is the exclusive focus on text-based conversational data, without incorporating any audio implementations through Text-to-Speech (TTS) technologies. This restriction to text-only interactions significantly narrows the scope of potential applications, particularly in scenarios where voice-based interactions are crucial. In the modern digital landscape, where voice-assisted technologies (e.g. conversational AI, conversational analytics) and audio-based interaction channels (e.g. IVRs, online meeting platforms) play increasingly prominent roles, the absence of audio capabilities in the conversational data simulation process can be a critical drawback.

### SUMMARY

Embodiments of the present application address the necessity for conversational data and the constraints tied to both real and synthetic data used to address that need. Embodiments of the present application address these challenges head-on by introducing a novel approach to synthetic conversational data generation through the interaction of two or more Large Language Models (LLMs), or even one Large Language Model (LLM) effectively implementing two or more LLMs simultaneously. Here, synthetic data can be employed as a substitute for real-world data, maintaining identical patterns and traits while obviating the necessity for accessing confidential or sensitive information. Synthetic data generation powered by LLMs are a good candidate for information production aligned with patterns of real data. By simulating conversations between two or more LLMs, embodiments of the present application avoid the ethical and privacy issues associated with using real human dialogues, thereby providing a fast and efficient method for obtaining realistic synthetic data capturing the nuances of real human conversation for the training and/or testing of conversational AI platforms, utilizing, for example, generative neural networks. The methods and systems of the present application can avoid the cost, complexity and risks associated with obtaining real conversation data for purposes of forming and improving conversational AI platforms, thereby providing for faster and more efficient training with a wider range of topics and subject matter upon which the training is based. For example, embodiments of the present application can offer a boundless and controllable environment to generate diverse, context-rich conversational datasets that are free from personal or sensitive information. This approach not only ensures privacy and ethical integrity but also provides unparalleled flexibility in data generation. The ability to simulate various conversational scenarios, styles, and complexities without the constraints of real-world data collection enables comprehensive testing and demonstration. The synthetic data generated can cover an extensive range of interactions, from routine exchanges to complex, nuanced dialogues, offering a robust foundation for evaluating conversational systems across diverse domains and use cases. Moreover, embodiments of the present application can significantly streamline the data generation process, eliminating the logistical and resource-intensive burdens associated with collecting real conversational data. This efficiency for data generation is significant for rapidly evolving conversational technologies, where the ability to quickly adapt and respond to emerging trends and requirements is important.

The authenticity of the synthetic data provided by embodiments of the present application for training and/or testing conversational AI platforms proceeds from the design which not only generates LLM backed synthetic data but also integrates to function as a comprehensive end-to-end scenario. The structure of the system embodiments involves interaction design, orchestration, and conversation structuring.

Unlike narrow-scoped conversational data simulated by the prior art solutions, embodiments of the present application provide a practical system for generating synthetic datasets capable of mimicking a variety of conversational scenarios across different domains with minimal effort required. Examples of simulated conversational data could include dialogs between customers and customer service agents in contact centers, or interactions between doctors and patients conducted on an online platform. Due to the intensive prompt generation capabilities of the LLM service employed in system and method embodiments, the systems and methods can produce conversational data across numerous domains, thus overcoming the diversity limitations present in existing methods. As an example, a sample conversation generated could be a scenario within a contact center of an imaginary bank, specifically an outbound call for a collection scenario conducted on an interactive voice response (IVR) system. The Bot Builder Service of exemplary embodiments can allow pre-definition of domain, sub-domain, speaker persona, language, conversational history, and simulated personal data variables such as, for example, speaker name and company name. All these settings help in tailoring the conversational flow to a specific scope.

The generated conversational data of method and system embodiments can be provided in either text or audio formats according to the envisaged conversational channel. For this purpose, the preferred embodiments embrace both text and audio data, unlike common examples. This provides a versatile alternative to a text-only approach, where LLMs solely generate textual data. One advancement provided by preferred embodiments includes swiftly incorporating speech synthesis and voice cloning technologies into the design, enabling an audio-based conversation between the LLM-based speakers. Additional differentiating proficiency of exemplary embodiments of the present application is dependent upon voice cloning services that can employ a limitless selection of speech synthesis voice types, thereby enhancing the warmth and naturalness of interactions. Cloned voices in accordance with exemplary embodiments provide the impression that they are of companions, making the user experience more engaging and comfortable, emphasizing the human-like simulated dialog.

This innovation presents another fundamental solution to challenges faced in generating synthetic data. Embodiments employing this method eliminate the need of adherence to a specific conversational norm. To be more specific, generating outputs that are unnatural, dull, and devoid of empathy are no longer valid in a world rapidly digitalizing user engagement. Embodiments of the present application create contextually aware natural variations in human language dialogue data, as opposed to rigid and stylized responses. To break free from the monotonous content generation, embodiments employ conversation-specific information coherent with the designed scenario and domain. This enables prompt engineering with the ability to provide conversation-specific information such as, for example, domain and/or sub-domain of the conversation, language, role-play characteristics, etc. The specifications defined through the Bot Builder of preferred embodiments enables emergence of prompting which can be guided to obtain desired generative outputs. Additionally, novel aspects of preferred embodiments include orchestration of language services such as LLMs, TTS and Voice Cloning collectively to obtain a more integrated solution applicable to various use cases.

On exemplary embodiment is directed to a method for training a neural network. In accordance with the method, synthetic data is generated by defining roles for a plurality of speakers, inputting the roles to at least one Large Language Model (LLM) implemented by at least one first processor, requesting the LLM(s) to generate a first statement based on the role of a first speaker of the plurality of speakers, instructing the LLM(s) to generate a second statement based on the role of a second speaker of the plurality of speakers that is responsive to the first statement, storing a dialog between the first speaker and the second speaker comprising the first and second statements, iterating the requesting, instructing and storing such that the first statement is responsive to the second statement of a preceding iteration of the requesting, the second statement is responsive to the first statement of a current iteration of the requesting instructing and storing, the storing comprises adding the first and second statements of a current iteration to the dialog such that the dialog comprises the first and second statements of each previous iteration of the requesting, instructing and storing, and each instance of the requesting and instructing comprises providing the LLM(s) with the dialog of a preceding iteration of the storing. Further, the method includes ceasing the iterating in response to a termination condition to obtain the stored dialog in a final iteration of the iterating, where the stored dialog in the final iteration is the synthetic data. Further, a neural network, implemented by at least one second processor, is trained based on the synthetic data.

In accordance with one exemplary aspect, the training comprises performing a first learning by the neural network based on other data and performing a second learning by the neural network based on the synthetic data to refine the neural network. For example, according to one exemplary feature, the other data is real data based on at least one real dialog.

In another exemplary aspect, the synthetic data is text data or audio data.

Further, according to another exemplary aspect, at least one of the roles of the first speaker or the second speaker comprise characteristics of the first speaker or the second speaker. Here, in accordance with one exemplary feature, the characteristics comprise at least one of: name, gender, age, address or occupation.

Another exemplary embodiment is directed to a system for generating synthetic data for the training and/or testing of neural networks. The system comprises at least one LLM module, a data storing unit and a bot builder service module, implemented by at least one processor. The bot builder service module is configured to perform defining of roles for a plurality of speakers, inputting the roles to the LLM module(s), requesting the LLM module(s) to generate a first statement based on the role of a first speaker of the plurality of speakers, instructing the LLM module(s) to generate a second statement based on the role of a second speaker of the plurality of speakers that is responsive to the first statement, storing, in the data storing unit, of a dialog between the first speaker and the second speaker comprising the first and second statements, iterating the requesting, instructing and storing such that the first statement is responsive to the second statement of a preceding iteration of the requesting, the second statement is responsive to the first statement of a current iteration of the requesting instructing and storing, the storing comprises adding the first and second statements of a current iteration to the dialog such that the dialog comprises the first and second statements of each previous iteration of the requesting, instructing and storing, and each instance of the requesting and instructing comprises providing the LLM module(s) with the dialog of a preceding iteration of the storing, and ceasing the iterating in response to a termination condition to obtain the stored dialog in a final iteration of the iterating, where the stored dialog in the final iteration is the synthetic data.

According to one exemplary aspect, the LLM module(s) provides each instance of the first and second statement as text data. Further, in accordance with an exemplary feature, the synthetic data is textual data. In addition, the dialog can be modeled for implementation on a dialog channel that is a text-based platform according to an exemplary feature.

In another exemplary aspect, the system includes a Text-to-Speech (TTS) Service module and a voice cloning service module implemented by the processor(s). Here, the TTS Service module is configured to convert the text data to audio data. In addition, the voice cloning service module is configured to clone at least one voice and convert the audio data into cloned audio data in the voice such that the synthetic data is stored as the cloned audio data. According to one exemplary aspect, the dialog is modeled for implementation on a dialog channel that is a voice-based platform. In accordance with another exemplary aspect, the dialog is modeled for implementation on a dialog channel that is both a textual-based platform and a voice-based platform.

Further, according to another exemplary feature, at least one of the roles of the first speaker or the second speaker comprises characteristics of the first speaker or the second speaker. Here, the characteristics can comprise, for example at least one of: name, gender, age, address or occupation.

Another exemplary embodiment is directed to a method for refining a conversation analytics platform. The method includes generating synthetic data by defining roles for a plurality of speakers, inputting the roles to at least one Large Language Model (LLM), implemented by at least one first processor, requesting the LLM(s) to generate a first statement based on the role of a first speaker of the plurality of speakers, instructing the LLM(s) to generate a second statement based on the role of a second speaker of the plurality of speakers that is responsive to the first statement, storing a dialog between the first speaker and the second speaker comprising the first and second statements, iterating the requesting, instructing and storing such that the first statement is responsive to the second statement of a preceding iteration of the requesting, the second statement is responsive to the first statement of a current iteration of the requesting instructing and storing, the storing comprises adding the first and second statements of a current iteration to the dialog such that the dialog comprises the first and second statements of each previous iteration of the requesting, instructing and storing, and each instance of the requesting and instructing comprises providing the at least one LLM with the dialog of a preceding iteration of the storing, and ceasing the iterating in response to a termination condition to obtain the stored dialog in a final iteration of the iterating, where the stored dialog in the final iteration is the synthetic data. The method further includes inputting the synthetic data to the conversation analytics platform, which is implemented by at least one second processor, and receiving feature results characterizing the synthetic data from the conversation analytics platform. Further, the feature results are compared to initial parameters including the roles for the plurality of speakers to determine whether at least one model portion of the conversation analytics platform is deficient. In addition, the model portion(s) of the conversation analytics platform is refined in response to determining that the model portion(s) of the conversation analytics platform is deficient.

According to one exemplary aspect, the synthetic data is first synthetic data and the method further includes generating second synthetic data, where the refining includes refining the model portion(s) of the conversation analytics platform with the second synthetic data. In accordance with another exemplary aspect, the second synthetic data is provided in a model training dataset and the refining includes training the model portion(s) with the model training dataset. Here, according to one exemplary feature, the model training dataset includes the first synthetic data.

### BRIEF DESCRIPTION OF THE DRAWINGS

In order to more clearly illustrate the embodiments of the present disclosure, a brief description of the drawings is given below. The following drawings are only illustrative of some of the embodiments of the present disclosure and for a person of ordinary skill in the art, other drawings or embodiments may be obtained from these drawings without inventive effort.

FIG. 1 is a block/flow a diagram a first exemplary embodiment of a system/method for generating synthetic data for training and/or testing of conversational artificial intelligence platforms;

FIG. 2 is a flow diagram of a method for generating synthetic data for training and/or testing of conversational artificial intelligence platforms in accordance with the first exemplary embodiment;

FIG. 3 is a diagram of illustrating a dialog generated in accordance with the first exemplary embodiment;

FIG. 4 is a diagram of is a block/flow a diagram a second exemplary embodiment of a system/method for generating synthetic data for training and/or testing of conversational artificial intelligence platforms;

FIG. 5 is a flow diagram of a method for training a neural network in accordance with a third exemplary embodiment; and

FIG. 6 is a flow diagram of a method for testing/refining/training a conversational analytics platform in accordance with a fourth exemplary embodiment.

### DETAILED DESCRIPTION

The technical solutions of the present disclosure will be clearly and completely described below with reference to the drawings wherein like reference numerals are used to refer to like elements throughout. The embodiments described are only some of the embodiments of the present disclosure, rather than all of the embodiments. All other embodiments that are obtained by a person of ordinary skill in the art on the basis of the embodiments of the present disclosure without inventive effort shall be covered by the protective scope of the present disclosure.

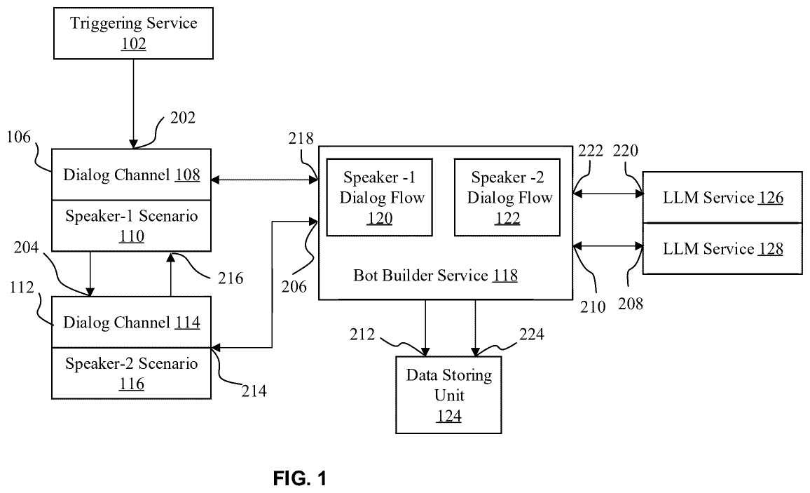

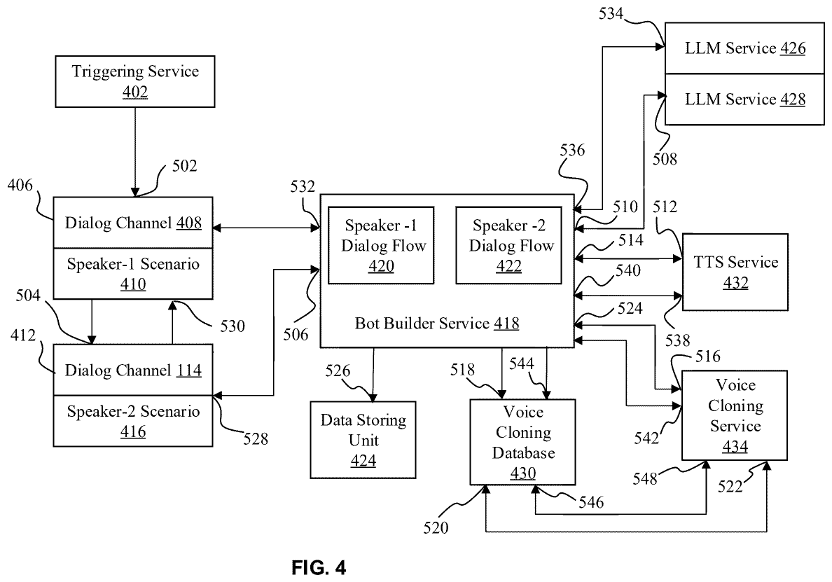

Referring now to FIG. 1, which depicts a block/flow diagram of an exemplary first embodiment of a system/method for generating synthetic data for the training and/or testing of conversational artificial intelligence platforms, which can be implemented by, for example, one or more neural networks. It should be understood that teach of the blocks depicted in FIG. 1, and FIG. 4, can be implemented by a variety of hardware that is disposed in a single device, or on multiple devices that communicate through wired or wireless networks, including the internet. Examples of hardware that can implement the Triggering Service 102, Dialog Channel Speaker-1 Scenario 106 (which includes the dialog channel 108 and Speaker-1 Scenario 110), Dialog Channel Speaker-2 Scenario 112 (which includes the dialog channel 114 and Speaker-2 Scenario 116), Bot Builder Service 118, LLM Service 126, LLM Service 128, Triggering Service 402, Dialog Channel Speaker-1 Scenario 406 (which includes the dialog channel 408 and Speaker-1 Scenario 410), Dialog Channel Speaker-2 Scenario 412 (which includes the dialog channel 414 and Speaker-2 Scenario 416), Bot Builder Service 418, LLM Service 426, LLM Service 428, Text-to-Speech Service 432 and Voice-Cloning Service 434 include one or more processors implemented by any one or more of central processing unit(s) (CPU(s)), graphics processing unit(s) (GPU(s)), tensor processing unit(s) (TPU(s)), field-programmable array(s) (FPGA(s)), and/or cloud computing system(s), and can employ storage mediums that can include memory systems, including for example, Random Access Memory (RAM) and/or Read Only Memory (ROM), and/or can include storage devices, such as, for example, solid-state drives (SSDs), hard disk drives (HDDs) and/or hybrid hard drives (HHDs). These one or more processors can be implemented at least partially by quantum computing devices, Edge AI hardware and other types of hardware. Further, the data storing unit 124, data storing unit 424 and the Voice Cloning Database 430 can be implemented by any one or more of SSDs, HHDs, HDDs or other storage mediums.

In the blocks of FIG. 1, Speaker-1 denotes the first entity or module that initiates the conversation. Speaker-1 acts as one side of the dialogue, typically starting the interaction. Speaker-2 is implemented by an LLM service or module 128 and responds to Speaker-1, effectively taking the role of the second participant in the simulated conversation. Text A denotes the first prompt text generated by the LLM Service 128 as a response to the initial request in this case. Text A represents the content of the dialogue generated by the LLM service 128 as Speaker-2 to convey to Speaker-1. Text B denotes a prompt text generated by the LLM Service 126 as the Speaker-1 side of the conversation, which will be delivered back to the Bot Builder Service 118 and further passed on to the Speaker-2 Scenario 116, thereby keeping the conversation going. The Speaker-1 Scenario 110 denotes a module that represents one half of the simulated conversational exchange within the system. The Speaker-1 Scenario 110 simulates one side of a dialogue and is designed to interact with Speaker-2, providing a dynamic conversational experience. The Speaker-2 Scenario 116 denotes a module that is the counterpart to Speaker-1 in the dialogue exchange. The Speaker-2 Scenario 116 receives input from Speaker-1, processes it, and generates a response, continuing the dialogue. Triggering Service 102 denotes a module that initiates the conversation, representing a part of Speaker-1. The conversation can be triggered by various actions, with a Hypertext Transfer Protocol (HTTP) client action, for example, implementing the Triggering Service 102. The Triggering Service 102 activates the conversational scenario for Speaker-1 in the Dialog Channel 108. A dialog channel represents the medium through which dialogs take place, such as, for example, instant messaging platforms, and dialog channel 108 denotes a module representing the Speaker-1 side of the dialog channel modeled in the system. Similarly, dialog channel 114 denotes a module representing the Speaker-2 side of the dialog channel modeled in the system. The HTTP client, when implementing the Triggering Service 102, for example, functions as a software utility that facilitates the sending of requests and the receiving of responses via the Hypertext Transfer Protocol. Within the context of the present embodiment, an HTTP client can be used to interact with the system's other components by initiating actions or sending parameters that influence the conversation flow. Dialog Channel Speaker-1 Scenario 106 and Dialog Channel Speaker-2 Scenario 112 respectively represent mediums for conversation, such as instant messaging platforms, where Speaker-1 Scenario 110 and Speaker-2 Scenario 116 are the conversational partners. The Speaker-1 Scenario 110 begins the dialogue, and the Speaker-2 Scenario 116 responds, both facilitated by the Dialog Channel modeled in the system. The Bot Builder Service 118 denotes a module that is a central service which orchestrates the conversation flow between the Speaker 1 and the Speaker 2. The Bot Builder Service 118 processes the initial request from the Speaker-2 Scenario 116 to commence dialogue, and based on pre-defined initial parameters (such as, for example, domain, sub-domain, language, and role-play characteristics), the Bot Builder Service 118 interacts with the LLM service 126 and LLM service 128 to generate appropriate responses. In this way, for example, the Bot Builder Service 118 implements the Speaker-1 dialog flow 120 and the Speaker-2 dialog flow 122. The LLM service 126 and LLM Service 128 are Large Language Model Services that take the input from the Bot Builder Service 118 and generate a text-based response (e.g. Text A or Text B) that is contextually relevant to the conversation parameters provided. If an AI model that is more advanced than LLM is published, that AI model can be used in lieu of LLM service 126 and/or LLM Service 128 and should be considered equivalent to an LLM service for purposes of implementation in the present embodiments. In addition, in accordance with one exemplary aspect, the functions of LLM service 126 and LLM Service 128 can be implemented by a single LLM service. The Data Storing Unit 124 stores the dialogue data, including Text A and subsequent text prompts such as Text B, for example. This data can be used for conversational artificial intelligence platform training, analysis, review, and testing, or to continue the conversation in later sessions. The block/flow diagram shows how Text A is transmitted between the Dialog Channel scenarios 106 and 112 and the Bot Builder Service 118 to maintain the conversation's flow.

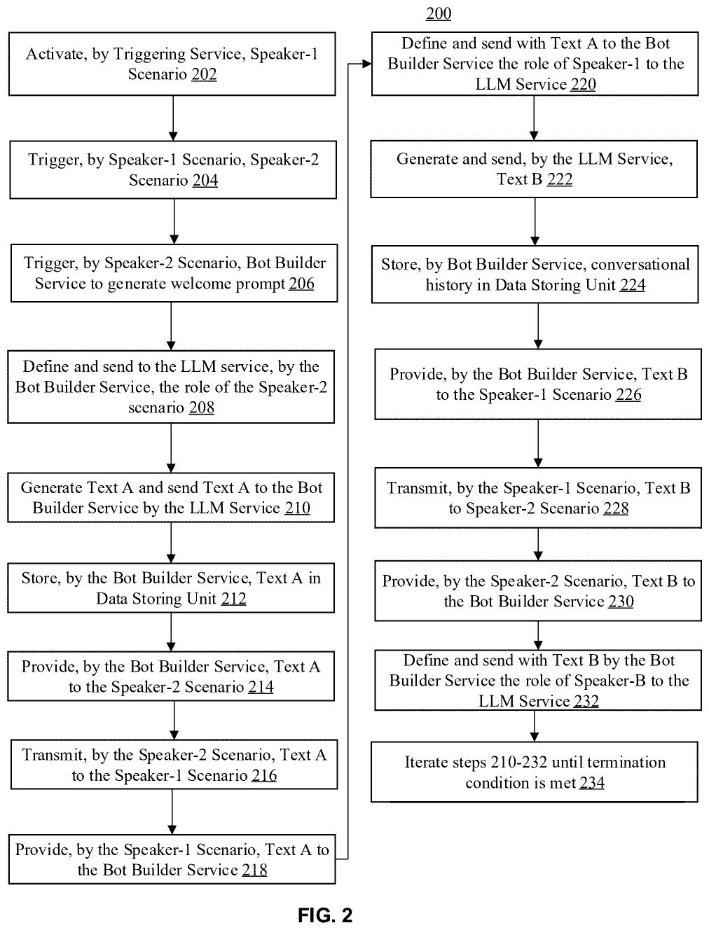

Turning now to FIG. 2, with continuing reference to FIG. 1, a flow diagram of a method 200 for generating synthetic data for the training and/or testing of neural networks in accordance with the first exemplary embodiment is illustratively depicted. At step 202, the triggering service 102 activates the Speaker-1 Scenario 110. In particular, representing Speaker-1, the triggering service 102 initiates a text-based conversational dialog by activating the Dialog Channel Speaker-1 Scenario 106. This triggering service 102 activates the Speaker-1 Scenario by implementing, for example, an HTTP client action. In addition, the Dialog Channel represents the medium through which dialogs take place, such as instant messaging platforms, as discussed above.

At step 204, the Speaker-1 scenario 110 triggers the Speaker-2 scenario 116. For example, the Dialog Channel Speaker-1 Scenario 106 initiates a conversational dialog with the Dialog Channel Speaker-2 Scenario 112.

At step 206, the Speaker-2 scenario 116 triggers the Bot Builder Service 118 to generate an initial prompt, for example, a welcome prompt. For example, upon receiving the conversational dialog, the Dialog Channel Speaker-2 Scenario 112 makes a request to the Bot Builder Service 118 to start a simulated conversation. This request may be a blank request solely intended to trigger a welcome prompt.

At step 208, the Bot Builder Service 118 defines a role of the Speaker-2 Scenario and sends the role to the LLM service 128. For example, the Bot Builder Service 118 executes the Speaker-1 Dialog Flow 120 which sends a request to the LLM service containing all the conversation-specific information specified during the design stage. This information may include the domain and/or sub-domain of the conversation, language, role-play characteristics, etc. To enhance prompt generation realism, simulated personal variables such as caller name, caller birth date, enterprise name, etc., are also defined and provided to the LLM service 128 through the Bot Builder Service 118. For example, the role information generated by the Bot Builder Service can include: “You are a customer representative named Jacob Walker. Here's a simulation for you: Imagine that you're a customer representative at company called Sestek Bank, and a customer called you via phone. What do you say for the first greeting?”

At step 210, the LLM Service 128 generates Text A and provides the generated text to the Bot Builder Service 118. For example, the LLM Service 128 responds to the Bot Builder Service 118 with a properly generated prompt text as Text A, for example, based on the role information provided at step 208. For example, the prompt text can be “Good afternoon, thank you for calling Sestek Bank, this is Jacob Walker speaking, how may I assist you today?”

At step 212, the Bot Builder Service 118 can store the Text A in the Data Storing Unit 124.

At step 214, the Bot Builder Service 118 provides the Text A to the Speaker-2 Scenario 106. For example, the Bot Builder Service 118 can deliver the prompt text to the Dialog Channel Speaker-2 Scenario 112.

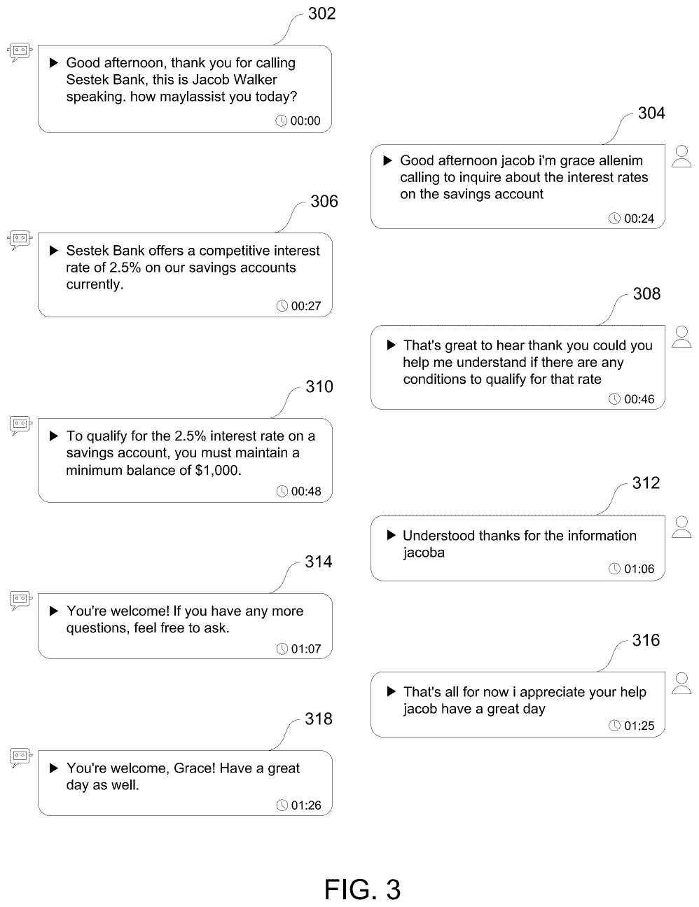

At step 216, the Speaker-2 Scenario 116 transmits the Text A to the Speaker-1 Scenario 110. For example, the Dialog Channel Speaker-2 Scenario 112 can forward the prompt text to the Dialog Channel Speaker-1 Scenario 106. As illustrated in FIG. 3, which depicts an exemplary dialog generated in accordance with the method 200, block 302 denotes the provision of the Text A generated at step 210 to the Speaker-1 Scenario 110.

At step 218, the Speaker-1 Scenario 110 provides the Text A to the Bot Builder Service 118. For example, the Dialog Channel Speaker-1 Scenario 106 transmits the Text A to the Bot Builder Service 118 to execute the Speaker-1 Dialog Flow 120 of the conversation.

At step 220, the Bot Builder Service 118 defines the role of Speaker-1 and sends the role, with Text A, to the LLM service 126. For example, the Speaker-1 Dialog Flow 120 of the Bot Builder Service 118 forwards Text A to the LLM Service 126 along with the dialog history and dialog-specific information, including the role of Speaker-1 defined by the Bot Builder Service 118. For example, the Bot Builder Service can provide the following to the LLM service 126: “You are a customer of a bank. Imagine that you are a customer that calls the bank. Your personal information includes Your name: Grace Allen, your birthday: 1982 Dec. 20, your account number: C060, your card number: 2345 9012 3456 7890, your phone number: +1987654321, your monthly income: 5800, address: 111 Bird Lane. The Agent told you ‘Good afternoon, thank you for calling Sestek Bank, this is Jacob Walker speaking, how may I assist you today?’, what do you say?”

At step 222, the LLM service 126 generates Text B based on the information received at step 220 and provides the Text B to the Bot Builder Service 118. For example, the LLM service 116 generates a new prompt text as Text B, this time for the Speaker-1 side of the conversation and delivers it to the Bot Builder Service 118. For example, the prompt text can be “Good afternoon, Jacob. I'm Grace Allen, I am calling to inquire about the interest rates on the savings account.”

At step 224, the bot builder service 118 stores the conversation history in the data storing unit 124.

At step 226, the Bot Builder Service 118 provides the Text B to the Speaker-1 Scenario 110. For example, the Bot Builder Service 118 can deliver the Text B to the Dialog Channel Speaker-1 Scenario 106.

At step 228, the Speaker-1 Scenario 110 transmits the Text B to the Speaker-2 Scenario 116. For example, the Dialog Channel Speaker-1 Scenario 106 can forward the Text B to the Dialog Channel Speaker-2 Scenario 112. As illustrated in FIG. 3, block 304 denotes the provision of the Text B generated at step 222 to the Speaker-2 Scenario.

At step 230, the Speaker-2 Scenario 116 provides the Text B to the Bot Builder Service 118. For example, the Dialog Channel Speaker-2 Scenario 112 transmits the Text B to the Bot Builder Service 118 to execute the Speaker-2 Dialog Flow 122 of the conversation.

At step 232, the Bot Builder Service 118 defines the role of Speaker-2 and sends the role, with Text B along with the conversation history, to the LLM service 128. For example, the Speaker-2 Dialog Flow 122 of the Bot Builder Service 118 forwards Text B to the LLM Service 128 along with the dialog history and dialog-specific information, including the role of Speaker-2 defined by the Bot Builder Service 118 at step 208, and request the LLM Service 128 to provide a response.

At block 234, steps 210-232 are repeated until the LLM driven Speakers generate a goodbye prompt to each other or certain threshold number of iterations are performed. For example, Text A is generated by the LLM Service 128 through the iterations and corresponds to blocks 306, 310, 314 and 318 in FIG. 3 provided by the Speaker-2 Scenario. In turn, Text B is generated by the LLM Service 126 through the iterations and corresponds to blocks 308, 312 and 318 in FIG. 3 provided by the Speaker-1 Scenario. During the simulated conversational dialog, Bot Builder Service 118 stores the dialog data in Data Storing Unit 124 in text format, which constitutes the synthetic data generated by the system and method of FIGS. 1-2 in accordance with the first exemplary embodiment.

Referring now to FIG. 4, which depicts a block/flow diagram of an exemplary second embodiment of a system/method for generating synthetic data for the training and/or testing of conversational artificial intelligence platforms, which can be implemented by, for example, one or more neural networks. In the blocks of FIG. 4, Speaker-1 denotes the first entity or module that initiates the conversation. Speaker-1 acts as one side of the dialogue, typically starting the interaction. Speaker-2 is implemented by an LLM service or module 428 and responds to Speaker-1, effectively taking the role of the second participant in the simulated conversation. Text A denotes the first prompt text generated by the LLM Service 428 as a response to the initial request. Text A represents the content of the dialogue generated by the LLM service 428 as Speaker-2 to convey to Speaker-1. Text B denotes a prompt text generated by the LLM Service 426 as the Speaker-1 side of the conversation, which will be delivered back to the Bot Builder Service 418 and further passed on to the Speaker-2 Scenario 416, thereby keeping the conversation going. The Speaker-1 Scenario 410 denotes a module that represents one half of the simulated conversational exchange within the system. The Speaker-1 Scenario 410 simulates one side of a dialogue and is designed to interact with Speaker-2, providing a dynamic conversational experience. The Speaker-2 Scenario 416 denotes a module that is the counterpart to Speaker-1 in the dialogue exchange. The Speaker-2 Scenario 416 receives input from Speaker-1, processes it, and generates a response, continuing the dialogue. Triggering Service 402 denotes a module that initiates the conversation, representing a part of Speaker-1. The conversation can be triggered by various actions, with an HTTP client action, for example, implementing the Triggering Service 402. The Triggering Service 402 activates the conversational scenario for Speaker-1 in the Dialog Channel 408. A dialog channel represents the medium through which dialogs take place, such as, for example, instant messaging platforms, and dialog channel 408 denotes a module representing the Speaker-1 side of the dialog channel modeled in the system. Similarly, dialog channel 414 denotes a module representing the Speaker-2 side of the dialog channel modeled in the system. The HTTP client, when implementing the Triggering Service 402, for example, functions as a software utility that facilitates the sending of requests and the receiving of responses via HTTP. Within the context of the present embodiment, an HTTP client can be used to interact with the system's other components by initiating actions or sending parameters that influence the conversation flow. Dialog Channel Speaker-1 Scenario 406 and Dialog Channel Speaker-2 Scenario 412 respectively represent mediums for conversation, such as instant messaging platforms, where Speaker-1 Scenario 410 and Speaker-2 Scenario 416 are the conversational partners. The Speaker-1 Scenario 410 begins the dialogue, and the Speaker-2 Scenario 416 responds, both facilitated by the Dialog Channel modeled in the system. The Bot Builder Service 418 denotes a module that is a central service which orchestrates the conversation flow between the Speaker 1 and the Speaker 2. The Bot Builder Service 418 processes the initial request from the Speaker-2 Scenario 416 to commence dialogue, and based on pre-defined parameters (such as, for example, domain, sub-domain, language, and role-play characteristics), the Bot Builder Service 418 interacts with the LLM service 426 and LLM service 428 to generate appropriate responses. In this way, for example, the Bot Builder Service 418 implements the Speaker-1 dialog flow 420 and the Speaker-2 dialog flow 422. The LLM service 426 and LLM Service 428 are a Large Language Model Services that take the input from the Bot Builder Service 418 and generate a text-based response (e.g. Text A or Text B) that is contextually relevant to the conversation parameters provided. If an AI model that is more advanced than LLM is published, that AI model can be used in lieu of LLM service 426 and/or LLM Service 428 and should be considered equivalent to an LLM service for purposes of implementation in the present embodiments. In addition, according to one exemplary aspect, the functions of LLM service 426 and LLM Service 428 can be implemented by a single LLM service.

In accordance with the second exemplary embodiment, the system further includes Text-to-Speech (TTS) Service 432, which is a module that converts the text prompts into audio, providing a spoken version of the conversation. Audio A is the initial audio output generated by the TTS service 432 from Text A. Audio A-clone is generated by a Voice Cloning Service 434 which is a module that subsequently processes Audio A to apply the desired vocal attributes that correspond to Voice ID-2 by using a Voice Recording-2 as a reference. The Audio A-clone represents the spoken version of Speaker-2's part of the conversation. Similarly, Audio B is the audio output generated by the TTS 432 service from Text B. Further, the Audio B-clone is generated by the Voice Cloning Service 434, which subsequently processes Audio B to apply the desired vocal attributes that correspond to Voice ID-1 by using Voice Recording-1 as a reference. Audio B-clone represents the spoken version of Speaker-1's part of the conversation. Voice ID-1 denotes a unique identifier for Speaker-1 assigned by the Bot Builder Service 418 to a specific voice type or voice sample within the Voice Cloning Database 430. Voice Recording-1 is the sample voice recording in Voice Cloning Database 430 that corresponds to Voice ID-1. Voice-ID-2 denotes a unique identifier for Speaker-2 assigned by the Bot Builder Service 418 to a specific voice type. Voice Recording-2 is the sample voice recording in Voice Cloning Database 430 that corresponds to Voice ID-2. In addition, the Voice Cloning Service 434 is a module that takes the audio from the TTS Service 432 and applies a chosen voice profile, creating a cloned audio output that mimics the characteristics of a specific voice recording, designated by a given voice ID. The Voice Cloning Database 430 stores various voice reference voice recordings that the Voice Cloning Service 434 can apply to the audio outputs to simulate different voices. The Data Storing Unit 424 archives all generated dialogues, both text and audio, as synthetic data for further use, such as analysis or future reference. In particular, this synthetic data can be used for conversational artificial intelligence platform training, analysis, review and testing. Further, this synthetic data can be used for neural network training, analysis, review and testing.

With continuing reference to FIG. 4, a method for generating synthetic data for the training and/or testing of conversational artificial intelligence platforms, which could be implemented by one or more neural networks, in accordance with the second exemplary embodiment is now described. At step 502, the triggering service 402 activates the Speaker-1 Scenario 410. In particular, representing Speaker-1, the triggering service 402 initiates a text-based conversational dialog by activating the Dialog Channel Speaker-1 Scenario 406. This triggering service 402 activates the Speaker-1 Scenario by implementing, for example, an HTTP client action. In addition, the Dialog Channel represents the medium through which dialogs take place, such as instant messaging platforms, as discussed above.

At step 504, the Speaker-1 scenario 410 triggers the Speaker-2 scenario. For example, the Dialog Channel Speaker-1 Scenario 406 initiates a conversational dialog with the Dialog Channel Speaker-2 Scenario 412.

At step 506, the Speaker-2 scenario 416 triggers the Bot Builder Service 418 to generate an initial prompt, for example, a welcome prompt. For example, upon receiving the conversational dialog, the Dialog Channel Speaker-2 Scenario 412 makes a request to the Bot Builder Service 418 to start a simulated conversation. This request may be a blank request solely intended to trigger a welcome prompt.

At step 508, the Bot Builder Service 418 defines a role of the Speaker-2 Scenario and sends the role to the LLM service 428. For example, the Bot Builder Service 418 executes the Speaker-2 Dialog Flow 422 which sends a request to the LLM service 428 containing all the conversation-specific information specified during the design stage. This information may include the domain and/or sub-domain of the conversation, language, role-play characteristics, etc. For example, the information can be the same as discussed above with respect to the first exemplary embodiment. To enhance prompt generation realism, simulated personal variables such as caller name, caller birth date, enterprise name, etc., are also defined and provided to the LLM service 428 through the Bot Builder Service 418. For example, the role information generated by the Bot Builder Service 418 can include: “You are a customer representative named Jacob Walker. Here's a simulation for you: Imagine that you're a customer representative at company called Sestek Bank, and a customer called you via phone. What do you say for the first greeting?” It should be understood that the roles discussed above with respect to the first exemplary embodiment can be used in the second exemplary embodiment. In addition, the Text A and Text B of the second exemplary embodiment can be the same as the Text A and Text B of the first exemplary embodiment and can be generated in the same way as the first exemplary embodiment. For example, the dialog of FIG. 3 can be generated by the second exemplary embodiment.

At step 510, the LLM Service 428 generates Text A and provides the generated text to the Bot Builder Service 418. For example, the LLM Service 428 responds to the Bot Builder Service 418 with a properly generated prompt text as Text A, for example, based on the role information provided at step 508. For example, as the prompt text can be “Good afternoon, thank you for calling Sestek Bank, this is Jacob Walker speaking, how may I assist you today?”

At step 512, the Bot Builder Service 418 forwards Text A to the TTS Service 432. In turn, at step 514, the TTS Service 432 synthesizes speech and returns the audio version as Audio A.

At step 516, the Bot Builder Service 418 then delivers Audio A to Voice Cloning Service 430.

At step 518, the Bot Builder Service 418 generates and stores a voice ID (Voice ID-2) and sends it to the Voice Cloning Database 430.

At step 520, the Voice Cloning Service 434 sends a request to the Voice Cloning Database 430 to select the reference voice recording, e.g., Voice Recording-2, that corresponds to Voice ID-2 generated by the Bot Builder Service 418.

At step 522, the Voice Cloning Service 434 applies a voice cloning process to Audio A by using Voice Recording-2 as a reference to generate cloned audio, Audio A-clone, based on the Audio A and Voice Recording-2.

At step 524, the Voice Cloning Service 434 delivers the cloned audio, Audio A-clone, to the Bot Builder Service 418.

At step 526, the Bot Builder Service 418 stores the Audio A-clone in the Data Storing Unit 424.

At step 528, the Bot Builder Service 418 delivers Text A to the Dialog Channel Speaker-2 Scenario 412.

At step 530, the Dialog Channel Speaker-2 Scenario 412, forwards the Text A to the Dialog Channel Speaker-1 Scenario 406.

At step 532, the Dialog Channel Speaker-1 Scenario 406 transmits the Text A to the Bot Builder Service 418 to execute the Speaker-1 Dialog Flow 420 of the conversation.

At step 534, the Speaker-1 Dialog Flow 420 of the Bot Builder Service 418 forwards Text A to the LLM Service 426 along with the dialog history and dialog-specific information, including the role of Speaker-1. For example, the Bot Builder Service 418 can perform step 534 in the same way that the Bot Builder Service 118 performed step 220.

At step 536, the LLM service 426 generates a new prompt text, Text B, for the Speaker-1 side of the conversation and delivers the Text B to the Bot Builder Service 418.

At step 538, the Bot Builder Service 418 forwards the prompt Text B to the TTS Service 432 for speech synthesis. In turn, at step 540, the TTS Service 432 generates an audio, Audio B, based on the Text B that is an audio version of the content of Text B and provides Audio B to the Bot Builder Service 418.

At step 542, the Bot Builder Service 418 transmits the Audio B to Voice Cloning Service 434.

At step 544, the Bot Builder Service 418 generates and stores a voice ID, Voice ID-1, and sends Voice ID-1 to the Voice Cloning Database 430.

At step 546, the Voice Cloning Service 434 sends a request to the Voice Cloning Database 430 for the reference voice recording, Voice Recording-1, that corresponds to the Voice ID-1 generated by the Bot Builder Service 418.

At step 548, the Voice Cloning Service 434 applies a voice cloning process to Audio B by using Voice Recording-1 as a reference to produce a cloned audio, Audio B-clone, that is a clone of Audio B, and delivers the Audio B-clone to the Bot Builder Service 418.

Thereafter, the method repeats for subsequent iterations, similar to the method 200. The number of iterations can be defined by a threshold count number within the scenario flows 420 and 422 in the Bot Builder Service 418. The conversational dialog simulation can conclude when the LLM driven speakers generate goodbye prompts to each other or certain number of threshold iterations are performed. During the simulated conversational dialog, the Bot Builder Service 418 stores the dialog data in Data Storing Unit 424 in audio format. The method in accordance with the second embodiment is essentially the same as the method 200 except that the TTS Service 432, the Voice Cloning Service 434 and the Voice Cloning Database 430 have been utilized to provide Audio clone versions of Text A and Text B in a dialog stored in the Data Storing Unit 424 as the synthetic data.

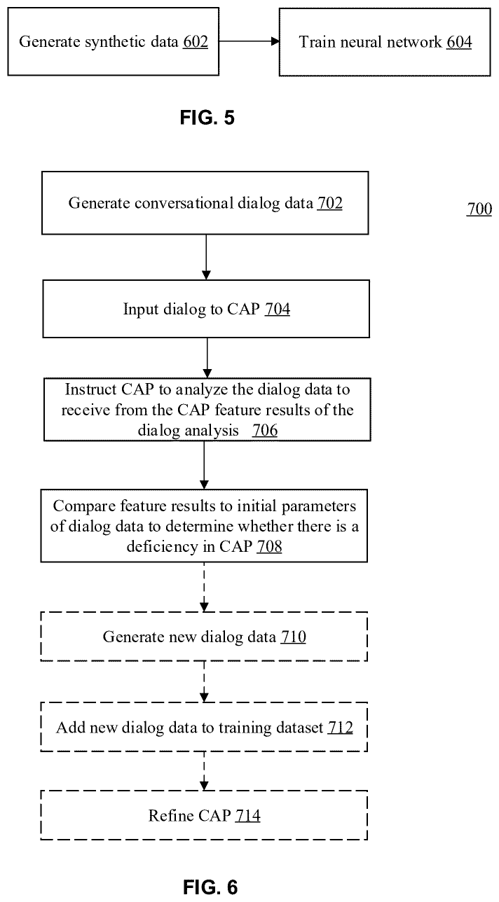

Referring now to FIG. 5, with continuing reference to FIGS. 1-4, a method 600 for training a neural network in accordance with a third exemplary embodiment is illustratively depicted. As discussed above, in accordance with an exemplary embodiment, the neural network can implement a conversational artificial intelligence platform. In accordance with the third exemplary embodiment, the first and/or second exemplary embodiments described above are implemented within the method 600. At step 602, the methods described above with respect to FIGS. 1 and/or 4 can be implemented in their entirety within step 602. For example, synthetic data can be generated by the systems described above with respect to FIGS. 1 and/or 4 and in accordance with the methods described above with respect to FIGS. 1-3 and/or FIG. 4. For example, the bot builder service 118/418 can define roles of Speaker-1 and Speaker-2 as discussed above with respect to steps 208 and 220, and/or with respect to step 508. Here, the roles can include characteristics of the speakers, such as the name, gender, age, address and/or occupation, as indicated above with respect to steps 208 and 220, and/or with respect to step 508 and 534. In addition, the Bot Builder Service 118/418 can input the roles of Speaker-1 and Speaker-2 to the LLMs 126 and 128, and/or LLMs 426 and 428, as discussed above with respect to steps 208 and 220, and/or steps 508 and 534. As discussed above, LLMs 126 and 128, and/or LLMs 426 and 428, can be combined into a single LLM. Further, the Bot Builder Service 118/418 can request that the LLMs 126 and 128, and/or LLMs 426 and 428, generate the text A, which is a statement, based on the role of Speaker-2, as discussed above with respect to steps 208 and 210, and/or steps 508 and 510. Additionally, the Bot Builder Service 118/418 can instruct the LLMs 126 and 128, and/or LLMs 426 and 428, to generate the Text B, which is a statement, that is responsive to Text A based on the role of Speaker-1 in accordance with steps 220 and 222, and/or steps 534 and 536. Further, as discussed above with respect to FIGS. 1 and 4, the Bot Builder Service 118 can store each Text A and B as a dialog in the data storing unit 124 as discussed above, for example, with respect to steps 212 and 224. Alternatively, or additionally, the Bot Builder Service 418 can store the Audio A-clone and Audio B-clone, which are statements, and are audio versions of texts A and B, respectively, in the Data Storing Unit 424 as discussed above with respect to FIG. 4. For example, the TTS Service module 432 can convert the text data to audio data, and the Voice Cloning Service module 434 can clone at least one voice and convert the audio data into cloned audio data, Audio A-clone and Audio B-clone, in the corresponding voice such that the synthetic data is stored as the cloned audio data, as discussed above with respect to FIG. 4. Moreover, the stored dialog can be in text format and modeled for a text-based platform, such as an instant messaging platform, or can be in audio format for a voice-based platform, such as a telephone call. In addition, the stored dialog can be a combination of text format and audio format and modeled for a dialog channel that is both a text-based platform and a voice-based platform, such as, for example a video call with a chat feature.

Moreover, at step 602, the requesting, instructing and storing can be iterated as discussed above with respect to FIGS. 1 and 4 and with respect to step 234. For example, after the Text A and B are generated and stored, the conversation continues with Bot Builder Service 118/418 iterating steps the method so that a new Text A is generated based on the dialog history so that it is responsive to the most recent Text B in the preceding iteration of the method. Similarly, a new Text B is generated based on the dialog history so that it is responsive to the most recent Text A, which is typically in the current iteration of the method in which this new Text B is generated. Furthermore, as discussed above with respect to FIGS. 1, 2 and 4, the Texts A and the Texts B, or audio-cloned versions of the Texts A and the Texts B, Audio A and Audio B clones, are stored in the data storing unit during each iteration to obtain a dialog, which is a conversation history between Speaker-1 and Speaker-2. The stored data can constitute the synthetic data and can be text data or audio data, as discussed above with respect to FIGS. 1 and 4. Further, as also discussed above, each instance of the requesting for a Text A from the corresponding LLM Service by the Bot Builder Service 118/418 can include the most recently stored conversation history. Similarly, as also discussed above, each instance of the instructing for the generation of a Text B from the corresponding LLM Service by the Bot Builder Service 118/418 can include the most recently stored conversation history. Further, the iteration can cease in response to a termination condition. For example, as discussed above, the iteration can end when one or more of the first Speaker-1 or the Speaker-2 provide a goodbye statement, or a threshold number of iterations has been reached. In addition, the iteration can end at any of the requesting, instructing or storing during a given iteration.

At step 604, a neural network can be trained based on the synthetic data by the Bot Builder Service 118/418 inputting the synthetic data into the neural network. For example, as discussed above, the synthetic data can be input to a neural network, such as an AI chatbot or LLM, which are examples of conversational artificial intelligence platforms, as training data. Here, the synthetic data can be input to the neural network in a first instance of learning by the neural network. Additionally or alternatively, the synthetic data can be input to the neural network as a second instance of learning that refines the neural network, where the neural network is trained in a first instance of learning on real data that is based on at least one real dialog. In either case, the generation of synthetic data significantly improves the speed and quality of the training of the neural network. For example, the synthetic data can be generated at will and quickly by the systems of FIGS. 1 and 4 and need not require obtaining real dialog data, which can be time consuming to retrieve and produce, as discussed above, and can also include privacy concerns. Moreover, the range of conversation topics can be tailored and increased to any desired scope based on configuration of the roles defined by the Bot Builder Service 118/418, and similarly is significantly faster to obtain for training/refining purposes than traditional methods of obtaining real dialog between people.

Another exemplary application of the first and second embodiments involves generating synthetic data for use in contact center load or regression tests. As contact centers aim for greater agility, they seek to implement changes quickly without sacrificing quality. Consequently, there's a growing demand for automating both functional and load testing capabilities. The systems in accordance with the first and second embodiments can generate artificial conversational data (synthetic data) for a variety of scenarios, enabling the testing of contact center capabilities. Examples of contact center capabilities to be tested can be the performance of IVR bots or the accuracy of the analytics tools, as discussed with respect to FIG. 6 below, for example. Alternatively, this data can be utilized to conduct regression tests, simulating customer dialogs to ensure proper performance in the event of changes to the contact center infrastructure, assessing any potential impacts on other aspects. The data can also be used to evaluate and tune conversational analytics platforms and contact center platforms, among others.

For example, with reference now to FIG. 6, with continuing reference to FIG. 4, a method 700 for testing/training/refining a conversational analytics platform (CAP) is illustratively depicted. The method 700 can be performed by any one or more processors described above with respect to FIGS. 1 and 4 using instructions stored on any memory and/or storage devices described above with respect to FIGS. 1 and 4. Similarly, the CAP can be implemented by any one or more processors described above with respect to FIGS. 1 and 4 using instructions stored on any memory and/or storage devices described above with respect to FIGS. 1 and 4. CAPs are widely used in the customer service sector to analyze contact center recordings and evaluate the customer service. The method 700 can be used to evaluate contact center interactions of customers and agents. In an example used herein to illustrate an application of the method 700, the conversation medium is a contact center IVR. Speaker-1 is the customer and Speaker-2 is the customer service agent in this case.

At step 702, the system of FIG. 4 is instructed to generate conversational dialog data, which is synthetic data, as discussed above with respect to FIG. 4. For example, dialog data for different conversational concepts can be generated by appropriately configuring pre-defined, initial parameters, such as, for example, domain, sub-domain, language, and role-play characteristics, to define the different conversation concepts, and inputting the pre-defined, initial parameters to the Bot Builder Service as discussed above with respect to FIGS. 1 and 4. As the medium is IVR, audio versions of the dialog data, in addition to text versions, are generated as well, via TTS and voice cloning, as discussed above with respect to FIG. 4. For example, for dialog 1, the customer persona, corresponding to Speaker-1, is defined as angry and Speaker-2 is defined as an empathetic agent that tries to calm the customer. The domain of the conversation is defined as a banking domain and the sub-domain is defined as credit card cancellation. Further, the pre-defined parameters state that Speaker-1 mentions that his name is John Smith and that his credit card number 123456 in this dialog 1.

At step 704, the dialog data is input into the CAP.

At step 706, the CAP is instructed to analyze the dialog data to receive, from the CAP, feature results of the dialog analysis. For example, the CAP analyzes the generated recordings/dialog data and the feature results of the analysis can be monitored by a module implementing the method 700 or manually at the dashboard screen of the CAP, for example. For example, the CAP can automatically transcribe the audio dialog data via a speech recognition functionality/model of the CAP and the transcribed text is received in return. In addition, the audio dialog data are classified according to their sentiment content via a sentiment detection functionality/model of the CAP. For example, the sentiment of the dialog 1 is reported by the CAP as being negative in this case. Further, the audio dialog data can be are classified according to their category via a text classification functionality/model of the CAP. As an example, the CAP can classify dialog 1 as a “credit card application” in this case and can output this classification. Additionally, the CAP can automatically identify the named entities in the conversation, e.g., customer name and customer service representative, via a named entity recognition (NER). Typically, the identification of the named entities are masked because they are personal data and should not be visible in CAP reports.

At step 708, the feature results are compared to the initial parameters of the conversational dialog to determine whether any functionality or model portion of the CAP is deficient and needs tuning. For example, as noted above with respect to step 702, the text version of the generated dialog can be included in the initial parameters here in accordance with an exemplary embodiment and can be obtained from the system of FIG. 4. Further, the transcribed text, which can be output by the CAP at step 706, can be compared with the generated text from the system of FIG. 4 to measure speech recognition accuracy. For example, the comparison may result in determining, by, for example, one or more processors implementing the method 700, that 95% of the text of Dialog 1 is transcribed correctly. Similarly, the accuracy of sentiment detection by the CAP can be determined. For example, as discussed above, with respect to step 702, the initial parameters can indicate that the Speaker-1 persona is an angry customer and, if the feature results indicate that the sentiment detection functionality determines that Speaker-1 is angry, then it is determined at step 708, based on a comparison between the Speaker-1 persona of the initial parameters and the Speaker-1 persona of the feature results, that the sentiment detection is accurate in this case. Further, as discussed above, with respect to step 702, the initial parameters can indicate that Dialog 1 is about credit card cancellation. If the feature results indicate that the automatic text classification model classifies the Dialog 1 as a “credit card application,” then, based on a comparison between the initial parameters and the feature results, it is determined at step 708, that the text classification model is not accurate for this case and would need to be tuned/corrected. Similarly, for the masking functionality, customer information of the initial parameters, which is defined as “John Smith” as the customer name and “123456” as the credit card number, can be compared to the output of the NER of the CAP. Here, if “customer name” is output by the NER of the CAP in place of “John Smith” and “credit card number” is output in place of “123456” by the NER of the CAP, then it is determined, at step 708, that the NER is properly implementing masking in the transcribed text and recorded audio of the dialog since both are personal data.

Thus, in this way, for example, the steps of the 702-708 of the method 700 can test the functionality of a CAP using synthetic data generated by the system/method of FIG. 4. Optionally, the synthetic data generated by the system/method of FIG. 4 can be further used to refine/train the CAP.

For example, optionally, at step 710, the system of FIG. 4 is instructed to generate new dialog data directed to any inaccurate/deficient feature results. For example, in the dialog 1 case described above, because the existing classification model categorized the test dialog as “credit card application” instead of “credit card cancellation,” the method 700 can generate new dialog data, e.g., 50 new dialogs, specifically defined under a “credit card cancellation” sub-domain with variations in the other initial parameters. It should be noted that the generation of the new dialog data can be directed to any feature result output by the CAP that was determined to be deficient/inaccurate at step 708 with the appropriate initial parameter directed to this feature result and with variations of the other initial parameters. For example, if a feature result output by the sentimentality of the CAP was determined to be inaccurate at step 708, e.g., that the customer Speaker-1 was happy, then the method 700 can generate new dialog data, e.g., 50 new dialogs or more, specifically defined under an “angry customer” role-play with variations in the other initial parameters. As discussed above, with respect to step 702, the pre-defined, initial parameters, such as, for example, domain, sub-domain, language, and role-play characteristics, can be input to the Bot Builder Service as discussed above with respect to FIGS. 1 and 4 to generate the new dialog data, which is synthetic data.

Optionally, at step 712, the new dialog data is added to a model training dataset. For example, the new dialogues, along with Dialog 1, can be added to the model training dataset, and defined, in the model training dataset, with the correct sub-domain information for the one or more functionalities of the CAP that is to be further trained. For example, in the main exampled discussed above, the automatic text classification model is to be further trained on dialogs directed to “credit card cancellation,” which is the same sub-domain information used during data generation at step 710.

Optionally, at step 714, the CAP is refined with the model training dataset. For example, the automatic text classification model of the CAP can be trained using the model training dataset to tune the model and improve the accuracy of the classification model.

It should be understood that a single dialog was used as an example for ease of understanding; however, in a practical application, it is preferable to generate many dialogs with different sets of parameters effortlessly to test/train the functionalities properly. If the accuracy rates are not acceptable, for example, in the exemplary scenario discussed above, the automatic text classification model was inaccurate, the models can be tuned or further trained with generated dialog data, as the generated dialog data is already tagged with features/characteristics correctly by the system of FIG. 4 since the initial parameters are defined before the dialog is generated, with no additional efforts, manual or by computer resources, required for tagging the data.

As discussed above, the generation of synthetic data significantly improves the speed and quality of the testing/training of the CAP and similar platforms, as the synthetic data can be generated effortlessly and quickly by the systems of FIGS. 1 and 4 and does not require procuring real dialog data, which can be time consuming and can risk the loss of privacy of individuals participating in the dialog. Moreover, a significant number of variations, essentially limitless, of the synthetic data can be generated efficiently and quickly, and tailored to any particular need, thereby providing a significant improvement in the testing/training of any desired aspect of a platform or neural network.

It should be further noted that another application of the first and second embodiments involves utilizing the generated conversation data as training material for roles that require effective or empathetic communication skills. Examples of these roles can be account managers, doctors or teachers. This training material can also serve as dialog practice for new language learners.

In accordance with other exemplary aspects, the systems described herein can incorporate an advanced feature that facilitates the simulation of conversations involving multiple speakers, significantly expanding the scope and versatility of synthetic conversational data generation. This capability allows for the creation of complex dialogue scenarios that more closely mirror real-world interactions, where conversations typically involve two or more participants. By enabling the orchestration of multi-speaker dialogues, the systems described herein can generate richer, more diverse datasets, capturing a wider range of conversational dynamics and nuances. This enhancement is particularly valuable for testing and demonstrating conversational systems that need to navigate the complexities of group interactions, making the synthetic data generation systems and methods described herein even more robust and adaptable to varied testing requirements.

Although the systems described herein can generate synthetic conversational data involving two or more participants, for the sake of clarity and brevity, this conversational data is referred to as dialog data herein, for which the process has been detailed accordingly.

Preferred embodiments of the present application are based on a system which generates simulated conversational dialog data through making LLMs talk to each other. In the future, if a better AI model than LLM is published, that AI model can be equivalently used as a substitute for LLM in the system and method embodiments described herein. Further, the systems described herein employ a Bot Builder System to design and orchestrate LLM speakers' dialog flows, a triggering service to initiate the system, a dialog channel to perform the dialog scenario, a large language model service to generate prompts, a TTS service to convert textual prompts into speech, a Voice Cloning Service to convert the TTS audio into a more suitable voice, a Voice Cloning Database to store reference voice recordings to be cloned in the converted TTS audio, and a data storing unit to store the generated conversational data.

The Bot Builder Service, as used herein, refers to a computer-implemented system or platform designed to facilitate the creation, customization, and management of conversational agents, commonly known as bots. This service typically includes features such as graphical user interfaces (GUIs), templates, and tools that enable users to design and define dialog flows, integrate with external systems, orchestrate the dialog flow, and deploy bots across various communication channels. The Bot Builder Service empowers users, including developers and non-technical personnel, to design and deploy conversational interfaces.

The system user designs a main scenario with the Bot Builder Service, comprising a branch of sub-conversational flow for each speaker. Here, “speakers” refers to conversational agents based on LLMs. In the case of simulated dialog data, at least two LLM-based speakers are required. Consequently, the main scenario flow designed through the Bot Builder Service will have two sub-conversational flow branches: Speaker-1 Dialog Flow and Speaker-2 Dialog Flow.

Dialog flows outline the structure and logic of a generated conversation, including the orchestration of the language services (e.g., LLM, TTS, Voice Cloning) to generate dialog prompts and the subsequent actions taken based on those responses. Dialog flows can be designed and managed within the Bot Builder Service's interface, allowing users to define the flow of conversation and customize the prompts generated by the LLM service to meet the scenario needs.

The concept of the conversation may be defined through the Bot Builder Service as an input. In this context, the concept of the conversation may encompass the domain and sub-domain of the conversation, speaker persona, conversational history, and simulated personal data variables, such as speaker name, company name, language etc. The conversation concept, encompassing a multitude of parameters such as the domain and sub-domain, speaker persona, conversational history, and simulated personal data variables like speaker names and company names, is primarily defined through inputs in the Bot Builder Service. However, the flexibility of the systems allows for these parameters (domain and sub-domain of the conversation, speaker persona, conversational history, and simulated personal data variables, such as speaker name, company name, language etc.) to be dynamically set or modified by the Triggering Service as well, tailoring the dialogue to specific requirements at any point in the conversation. While the language parameter is established at the outset of the interaction, other parameters can be adjusted on the fly by the Triggering Service, thereby offering a versatile and customizable approach to dialogue generation that can adapt to varying conversational scenarios in real time.

The dialog channel serves as the medium for executing the dialog scenario. This channel encompasses various platforms, including but not limited to IVR systems, instant messaging platforms, or online meeting platforms. The modalities of the conversational data may vary according to the channels preferred. This can include text-based conversations, voice-based interactions, or even multimodal interactions that combine both text and voice elements.

The process begins with the action of a triggering service to kickstart a conversation. A triggering service can be, but is not limited to, an HTTP client that constitutes a software component or module within a computational system designed to initiate requests and receive responses through HTTP.

The triggering service generates a triggering action to activate the Dialog Channel Speaker-1 Scenario so that the Dialog Channel Speaker-1 Scenario initiates a conversational dialog with the Dialog Channel Speaker-2 Scenario. In this context, Dialog Channel Speaker-1 Scenario represents the speaker that initiates the conversation, while Dialog Channel Speaker-2 Scenario represents the second speaker's part. For example, in a real-life conversational scenario between human speakers, if a customer were to call a contact center IVR (Interactive Voice Response) System, where the call initiates the conversation, to reach a contact center agent, Dialog Channel Speaker-1 Scenario would represent the IVR Customer Scenario, while Dialog Channel Speaker-2 Scenario would represent the IVR Agent Scenario.

After receiving the request, the Bot Builder Service executes the Speaker-2 Dialog Flow of the pre-designed main conversational scenario, as explained in the system's design phase. The Speaker-2 Dialog Flow begins with a Welcome prompt and proceeds with a request executed by the Bot Builder Service to the LLM service. The primary purpose of this action is to request the LLM service to generate a suitable prompt that aligns with the concept of the conversational scenario. The request includes conceptual information about the conversation, such as the domain and sub-domain, speaker persona, conversational history, and simulated personal data variables like speaker name and company name.

In this context, the LLM service refers to a service that utilizes large language models, such as OpenAI's GPT (Generative Pre-trained Transformer) models or similar models developed by other organizations, for various natural language processing tasks. In the future if a better AI model than LLM is published, that AI model can be used as a substitute for LLM in the system and method embodiments described herein. While generating a prompt, the LLM Service utilizes its pre-trained model to analyze the input sent by Bot Builder Service and generate a text (Text A) that aligns with the given context and forwards it back to the Bot Builder Service. Text A represents the prompt generated for Speaker-2 to convey as a response to Speaker-1.

At this stage, the process flow can proceed in one of two ways, corresponding to the first exemplary embodiment and the second exemplary embodiment, according to the type of the conversational channel.

For example, in accordance with the first exemplary embodiment, if the medium is a text-based conversational channel, the Bot Builder Service delivers Text A directly to the Dialog Channel Speaker-2 Scenario and the Dialog Channel Speaker-2 Scenario forwards Text A to the Dialog Channel Speaker-1 Scenario. In this context, Speaker-2 represents the speaker that prompts Text A while Speaker-1 is the receiver of the prompt. Text A is also stored in Data Storing Unit.

At the next step, the Dialog Channel Speaker-1 Scenario forwards Text A to the Bot Builder Service, which then executes the Speaker-1 Dialog Flow of the pre-designed main conversational scenario. Speaker-1 Dialog Flow proceeds with a request executed by the Bot Builder Service to the LLM Service with Text A. The primary purpose of this action is to request the LLM service to generate a suitable prompt that aligns with the concept of the conversational scenario. Besides Text A, the request includes conceptual information about the conversation, such as the domain and sub-domain, speaker persona, conversational history, and simulated personal data variables like speaker name and company name. The LLM Service utilizes its pre-trained model to analyze the input sent by Bot Builder Service and generate a new text, Text B, that aligns with the given context and forwards it back to the Bot Builder Service. Text B represents the prompt generated for Speaker-1 to convey as a response to Speaker-2.

The process repeats itself for the subsequent iterations. The conversational dialog simulation concludes when the LLM driven Speakers generate goodbye prompt to each other or certain number of iterations are performed.

During the simulated conversational dialog, the Bot Builder Service sends the dialog data to the Data Storing Unit for storage. For the first exemplary embodiment, the stored dialog data format is text.

In accordance with the second exemplary embodiment, if the medium is an audio-based conversational channel, the Bot Builder Service delivers Text A first to the TTS Service to synthesize the text and receive an audio in return as Audio A. The Bot Builder Service then delivers Audio A to Voice Cloning Service. The Voice Cloning Service utilizes artificial intelligence (AI) and machine learning algorithms to replicate and mimic a person's voice. It involves capturing the unique characteristics of an individual's speech patterns, intonations, and vocal nuances, and then generating synthesized speech that closely resembles the original voice. This setup also includes a Voice Cloning Database which stores reference voice recordings that are used for cloning by the Voice Cloning Service.

The Bot Builder Service randomly generates and stores a voice ID, Voice ID-2, and sends Voice ID-2 to the Voice Cloning Database. The Voice Cloning Service sends a request to the Voice Cloning Database to choose the reference voice recording, Voice Recording-2, that corresponds to Voice ID-2 generated by the Bot Builder Service. The Voice Cloning Service applies a voice cloning process to Audio A by using Voice Recording-2 as a reference and delivers cloned audio, Audio A-clone, to the Bot Builder Service. Audio A-clone is stored in Data Storing Unit. Bot Builder Service stores and records voice IDs it creates for the next iterations of the dialog. In this scenario, Voice ID-2 represents the voice tone of Speaker-2 and Speaker-2 represents the speaker that prompts Audio A-clone, while Speaker-1 is the listener of the audio.

The Bot Builder Service then delivers Text A to the Dialog Channel Speaker-2 Scenario and then The Dialog Channel Speaker-2 Scenario forwards Text A to the Dialog Channel Speaker-1 Scenario. The Dialog Channel Speaker-1 Scenario transmits Text A to the Bot Builder Service to execute the Speaker-1 Dialog Flow of the conversation.

The Speaker-1 Dialog Flow proceeds with a request executed by the Bot Builder Service to the LLM Service with Text A. The primary purpose of this action is to request the LLM service to generate a suitable prompt that aligns with the concept of the conversational scenario. Besides Text A, the request includes conceptual information about the conversation, such as the domain and sub-domain, speaker persona, conversational history, and simulated personal data variables like speaker name and company name. LLM Service utilizes its pre-trained model to analyze the input sent by Bot Builder Service and generate a text, Text B, that aligns with the given context and forwards Text B back to the Bot Builder Service. Text B represents the text prompt generated for Speaker-1 to convey as a response to Speaker-2.

To transform Text B into audio format as Audio B, the Bot Builder Service forwards Text B to the TTS service and requests the TTS service to synthesize an audio version of Text B and receives an audio in return as Audio B from the TTS service. The Bot Builder Service then delivers Audio B to the Voice Cloning Service. The Bot Builder Service generates and stores a voice ID, Voice ID-1, and sends Voice ID-1 to the Voice Cloning Database. The Voice Cloning Service sends a request to the Voice Cloning Database to choose the reference voice recording, Voice Recording-1, that corresponds to the Voice ID-1 generated by the Bot Builder Service.

The Voice Cloning Service applies a voice cloning process to Audio B by using Voice Recording-1 as a reference and delivers cloned audio, Audio B-clone, that is based on Audio B to the Bot Builder Service. In this scenario, Voice ID-1 represents the voice tone of Speaker-1.

The process repeats itself for the subsequent iterations. The conversational dialog simulation concludes when the LLM driven Speakers generate goodbye prompt to each other or a certain number of iterations are conveyed, and this final prompt is transformed into audio.

During the simulated conversational dialog, the Bot Builder Service sends the dialog data to the Data Storing Unit for storage of the dialog data as synthetic data. For the second exemplary embodiment, the stored dialog data format is audio.

Thus, in accordance with embodiments described herein, simulated conversational dialog data is generated through making LLMs talk to each other. Using LLMs for the generation of conversational data broadens conversational content and accelerates the generation of data without the need for any personal data. Besides text-based conversational data, the generated data can also be audio-based conversational data due to the speech synthesis and voice cloning functionalities. The second exemplary embodiment described herein offers a limitless selection of speech synthesis voice types through its voice cloning service.

The speech synthesis and voice cloning feature described herein significantly enhances system capabilities, providing an extensive selection of customizable voice types for synthesis. This innovative feature allows for the generation of varied audio datasets, adeptly mirroring a spectrum of demographic traits including age, gender, and regional accents. Such diversity ensures that testing protocols are both inclusive and comprehensive, catering to a broad range of user interactions. The generated voice samples also support variable lengths for voice samples. This flexibility enables the generation of diverse audio datasets that can encompass a wide variety of testing scenarios and training, further enhancing the system's inclusivity and comprehensiveness.

Embodiments described herein facilitate the design of conversational flow through the functionalities of the Bot Builder Service. The Bot Builder Service allows the flow to be conducted across a single conversational scenario, which compromises the flows for all LLM-based speakers within one scenario design. This reduces the effort required for designing conversational scenario flows and system maintenance. Conceptual information about the conversation, such as the domain and sub-domain, speaker persona, language, conversational history, and simulated personal data variables, such as speaker name and company name can be pre-defined through the Bot Builder Service. This enables more natural, diverse, and realistic conversations. This conceptual information can be defined to the system once for all speakers, reducing the effort needed for scenario management.

Systems and methods described herein introduce a groundbreaking approach to synthetic conversational data generation, specifically addressing the constraints of conventional methods that were heavily reliant on real conversational data, fraught with privacy concerns, and limited in contextual scope and diversity. By using LLMs to simulate text-based dialogues, the embodiments described herein circumvent the need for real-world conversational datasets, thus eliminating the associated ethical and legal complexities. This feature is particularly advantageous in today's privacy-conscious environment, where the use of personal or sensitive information is heavily scrutinized.

Traditional synthetic dialog data generation has predominantly been oriented towards intent recognition, producing datasets that categorize user inputs based on predefined intents. While this has been effective for applications requiring simple command-response interactions, such methods do not encapsulate the dynamic nature of human conversations, which often involve multiple iterations, contextual understanding, and the ability to maintain continuity across exchanges. The limitation of intent-based data lies in its inability to replicate the nuanced, fluid dialogue characteristic of natural human interactions, which is increasingly demanded by sophisticated conversational systems designed for a wide array of interactive applications. The focus on generating synthetic conversational data described herein marks a significant departure from these traditional methodologies. By simulating text and audio-based dialogues that mirror the intricacies of human conversation, this system provides a more complex and contextually rich dataset. The emphasis on conversational rather than intent data facilitates the testing and demonstration of conversational systems that offer a more natural and intuitive user experience, capable of sustaining engaging and coherent interactions over multiple iterations. Moreover, the ability to generate detailed conversational data broadens the scope of potential applications for conversational technologies, enabling its testing cases in more diverse and challenging scenarios.

The embodiments described herein introduce a pioneering approach to generating synthetic conversational data, primarily intended for training, testing or demonstration purposes, marking a significant departure from existing methodologies in synthetic data generation. At the heart of this system is the novel concept of facilitating dialogues between two or more LLMs, a method that yields many advantages over prior technologies. As noted above, future AI models can be employed as a substitute for LLM and can be considered equivalent for purposes of implementing the embodiments in the invention system. This approach substantially widens the scope and accelerates the pace of conversational data generation, without necessitating access to real or personal data. This aspect is particularly advantageous in scenarios where data sensitivity and privacy concerns preclude the use of actual conversational datasets. By leveraging the capabilities of LLMs to simulate dialogues, the system ensures the generation of rich, diverse, and contextually varied data, mirroring the intricacies and dynamics of real-world conversations. The dialogues produced by the systems and methods described herein are not mere replications of pre-existing conversations but are instead dynamic and varied, capturing the essence of human interaction. This is achieved in part through the sophisticated capabilities of the LLMs, which are designed to understand and generate human-like text based on vast amounts of language data. When these models engage in simulated dialogues in accordance with the embodiments described herein, the result is a rich tapestry of conversations that reflect the depth, diversity, and complexity typical of human exchanges. This includes the ability to navigate a wide range of topics, exhibit varied conversational styles, and respond to an array of contextual cues, thereby producing data that is not only syntactically and semantically rich but also contextually nuanced. Furthermore, the systems and methods allow for the generation of conversational data across a broad spectrum of domains and scenarios, making it an invaluable tool for testing and demonstrating a wide variety of applications, as well as training conversational platforms. From customer service bots and virtual assistants to more specialized conversational agents, the synthetic data produced can serve as a robust testing ground, ensuring these systems are well-equipped to handle real-world interactions.

The versatility of the embodiments described here extend significantly through their capacity to generate both text-based and audio-based conversational data, a feature that considerably broadens its application spectrum. This dual capability is facilitated by the seamless integration of advanced speech synthesis functionalities into the system. This integration represents a pivotal advancement in synthetic conversational data generation, accommodating the growing demand for more immersive and realistic testing environments, particularly for applications reliant on audio interactions. By integrating advanced speech synthesis functionalities, the preferred embodiments described herein adeptly convert the generated textual dialogues into realistic audio formats and vice versa. This seamless transition between text and audio ensures that the synthetic conversational data closely mirrors real-world interactions, making it an invaluable asset for developers and researchers. For instance, in testing voice-activated systems or voice user interfaces, the availability of authentic-sounding audio data allows for a more rigorous assessment of the system's responsiveness and accuracy in recognizing and processing spoken commands or queries. The addition of a voice cloning service within this system further amplifies its utility by offering a wide array of customizable voice types for synthesis. This feature enables the creation of diverse audio datasets that can simulate different demographic characteristics, such as age, gender, and regional accents, thereby ensuring the inclusivity and comprehensiveness of testing protocols. For technologies that aim to serve a global user base, this capability ensures that the systems are well-tuned to understand and interact with voices from various cultural and linguistic backgrounds. While generating this synthetic data for testing and demonstration, the ability to produce audio-based data alongside text is particularly advantageous. It allows for the simultaneous evaluation of a system's text processing and voice processing capabilities, providing a more holistic view of its performance. For example, in the area of conversational agents or chatbots, the system can be tested against a wide range of scenarios and interaction modes, ensuring its robustness and versatility. Moreover, the audio data generated by this system can serve as a benchmark for testing speech recognition accuracy and the naturalness of speech synthesis in conversational AI applications. This is important for fine-tuning the user experience, ensuring that the interactions are as smooth and natural as possible.

Important to the ease of use and efficiency of the embodiments described herein is the Bot Builder Service, which streamlines the design of conversational flows. This service facilitates the orchestration of dialogues across a unified conversational scenario, encapsulating the flows for all LLM-based speakers within a single design framework. This consolidation significantly reduces the complexity and effort involved in scenario design and system maintenance, making the technology accessible to a broader range of users, including those with minimal technical expertise. Contrasting sharply with earlier methodologies that relied on real conversational data—often entangled in privacy concerns and limited by the scope of collected interactions—the Bot Builder Service introduces an unparalleled depth and realism to synthetic data. By enabling the pre-definition of various conceptual elements, such as the conversation's domain, sub-domain, speaker personas, and their historical context, this service ensures the generated dialogues are not just contextually accurate but also intricately detailed. This nuance and complexity closely mirror the dynamic and unpredictable nature of human conversations, surpassing the generic and contextually shallow outputs of traditional synthetic data generation methods. The advantages of the embodiments described herein over previously existing technologies are profound. They offer a privacy-compliant alternative to real data collection, sidestepping the ethical dilemmas and legal complications associated with using real conversational data. The Bot Builder Service enriches the synthetic data landscape with a diversity of dialogues that extend far beyond the limitations of existing datasets, enabling a broader range of testing and demonstration scenarios. This approach not only democratizes access to sophisticated data generation by simplifying the design process but also enhances the realism and customization of the generated conversations. Such detailed and lifelike dialogues provide a robust platform for more authentic and engaging user experiences in testing and demonstration environments, accelerating the development and refinement of conversational technologies.

In essence, the preferred embodiments described herein revolutionize the generation of synthetic conversational data, offering a solution that is both innovative and practical. Its approach to utilizing LLMs for dialogue simulation, combined with the versatility of data generation and the sophistication of the Bot Builder Service, positions the system and method embodiments as a critical tool for developers, researchers, and businesses seeking to enhance the testing and demonstration of technologies reliant on conversational data.

The above-mentioned embodiments of the present disclosure are only examples for describing the present disclosure more clearly, rather than limiting an implementation mode of the present disclosure. For those of ordinary skill in the art, other variations, alternatives or changes in different forms can be made on the basis of the above description. For example, while the above-described embodiments focus on generating synthetic conversational data using a dual LLM approach, alternative methodologies that can also contribute to advancements in conversational AI and synthetic data generation can also be employed in accordance with exemplary embodiments. One such alternative involves the use of rule-based systems in conjunction with machine learning algorithms. The integration of rule-based systems with machine learning algorithms represents a hybrid approach in the development of conversational data generation, combining the structured logic of rule-based systems with the adaptive learning capabilities of machine learning models. This method leverages a set of predefined rules that dictate the structure and flow of conversations, ensuring that interactions follow a logical sequence and adhere to specific conversational norms. These rules can be particularly effective in domain-specific applications, where conversations are expected to revolve around a limited set of topics and follow predictable patterns. Machine learning models complement this structured approach by introducing variability and context-awareness into the interactions. These models can learn from large datasets of real conversations, enabling them to understand the nuances of human language, adapt to the user's input, and generate responses that are relevant to the current context. This combination allows for a more dynamic interaction than would be possible with a purely rule-based system, making the conversations feel more natural and responsive to the user. However, this hybrid approach has its limitations. One significant challenge is the rigidity introduced by the reliance on predefined rules. While these rules ensure consistency and adherence to specific conversational frameworks, they can also constrain the system's flexibility, making it difficult to handle unexpected inputs or to deviate from the anticipated conversation flow. This can result in interactions that feel scripted or unnatural, especially in scenarios that fall outside the defined rules. Moreover, the success of this approach heavily depends on the quality and comprehensiveness of the rule set and the training data used for the machine learning models. Creating an extensive and effective rule set requires deep domain expertise and a thorough understanding of the conversational dynamics within that domain. Similarly, the machine learning models need large and diverse datasets to learn from, which can be challenging to acquire, especially for niche or specialized domains. Another limitation is the potential for increased complexity and maintenance effort. The need to continuously update and refine the rule set to accommodate new conversation scenarios, coupled with the ongoing training and tuning of the machine learning models, can result in significant resource expenditure. This can be particularly burdensome for smaller organizations or those with limited technical capabilities. These systems can leverage a predefined set of rules to guide conversations, with machine learning models employed to add variability and context- awareness to the interactions. Although less dynamic than LLM-based approaches, this hybrid method can offer a balance between predictability and adaptability, especially in domain-specific applications where the scope of conversations is relatively constrained.

Another alternative is the utilization of single LLM setups, where one sophisticated model acts both as the initiator and responder within conversations. The utilization of a LLM to act as both the initiator and responder within conversations presents an alternative in the development of conversational AI systems. This approach simplifies the overall system architecture by consolidating the conversational roles into one model, thereby reducing the complexity and potential overhead associated with coordinating multiple models or systems. However, this simplicity also introduces unique challenges that should be addressed to ensure the effectiveness of the conversational AI system. One of the primary challenges in using a single LLM for both initiating and responding to conversations is the need for the model to maintain a coherent and contextually relevant dialogue over multiple iterations. Unlike dual LLM setups where each model can be conditioned or fine-tuned for a specific conversational role, a single LLM must be capable of dynamically switching between these roles within the same interaction. This involves the model having a deep understanding of the context and the ability to retain relevant information from earlier parts of the conversation to inform its responses and subsequent initiations. To address this challenge, the single LLM should undergo rigorous tuning and conditioning to enhance its contextual awareness and memory capabilities. This involves training the model on diverse datasets that encompass a wide range of conversational scenarios and domains, enabling it to adapt to various topics and maintain relevance throughout the conversation. Additionally, techniques such as reinforcement learning, and prompt engineering can be employed to further refine the model's ability to generate coherent and contextually appropriate dialogue. Another consideration is the model's capacity to simulate the nuances of human conversation, including the ability to introduce new topics, ask relevant questions, and exhibit a range of conversational behaviors that are characteristic of natural human interactions. Achieving this level of sophistication in a single LLM requires a delicate balance between the model's generative capabilities and its ability to adhere to the conversational context and goals. Overall, this setup simplifies the system architecture but should involve careful tuning and conditioning of the LLM to ensure it can effectively simulate both sides of a conversation. The challenge here lies in maintaining a coherent and contextually relevant dialogue without the benefit of distinct, role-based perspectives offered by dual LLM systems.

Crowd-sourced conversational data and simulation-based approaches represent another alternative. By leveraging human interactions from crowd-sourcing platforms, it's possible to generate a rich dataset of real conversations, which can then be used to train conversational AI models. While this method provides access to authentic dialogues, it also presents challenges in terms of scalability, data privacy, and the need for extensive data cleaning and preprocessing. This method leverages interactions from crowd-sourcing platforms, where individuals contribute to conversation datasets by engaging in dialogues that are designed to cover a wide range of topics, scenarios, and conversational styles. The resultant datasets are rich in the diversity and complexity of natural human conversation, making them an excellent resource for training AI models to understand and generate human-like responses. One of the primary advantages of this approach is the authenticity and variability of the conversational data. Unlike synthetic data or data generated from a limited set of templates, crowd-sourced conversations capture the nuances, idiomatic expressions, and the unpredictable nature of human communication. This can lead to the development of conversational AI systems that are better equipped to handle the wide range of expressions, topics, and conversational dynamics they might encounter in real-world applications. However, despite its advantages, the crowd-sourcing approach comes with significant limitations and challenges. Scalability is one of the primary concerns, as the quality and usefulness of the data are directly dependent on the quantity and diversity of the crowd-sourced contributions. Gathering a large and diverse enough dataset to cover the vast range of possible conversational scenarios can be time-consuming and expensive, making it difficult to scale this approach to meet the needs of more complex or domain-specific applications. Data privacy and ethical considerations also pose significant challenges. Conversations may inadvertently contain personal, sensitive, or identifiable information, which raises concerns regarding participant privacy and data protection. Ensuring the anonymity and confidentiality of the data while maintaining its usefulness for AI training requires meticulous data handling and preprocessing protocols, which can be resource-intensive to implement and maintain. Furthermore, the need for extensive data cleaning and preprocessing cannot be overstated. Crowd-sourced conversations often include errors, off-topic discussions, and other noise that can degrade the quality of the training data if not properly addressed. Cleaning and preprocessing this data to ensure it is suitable for training conversational AI models is a labor-intensive process that involves not only removing or correcting errors but also annotating the data to provide the

AI with the context and structure it needs to learn effectively.

What is claimed is:

1. A method for training a neural network comprising:
generating synthetic data by
defining roles for a plurality of speakers,
inputting the roles to at least one Large Language Model (LLM) implemented by at least one first processor,
requesting the at least one LLM to generate a first statement based on the role of a first speaker of the plurality of speakers,
instructing the at least one LLM to generate a second statement based on the role of a second speaker of the plurality of speakers that is responsive to the first statement,
storing a dialog between the first speaker and the second speaker comprising the first and second statements,
iterating the requesting, instructing and storing such that
the first statement is responsive to the second statement of a preceding iteration of the requesting,
the second statement is responsive to the first statement of a current iteration of the requesting instructing and storing,
the storing comprises adding the first and second statements of a current iteration to the dialog such that the dialog comprises the first and second statements of each previous iteration of the requesting, instructing and storing, and
each instance of the requesting and instructing comprises providing the at least one LLM with the dialog of a preceding iteration of the storing,
ceasing said iterating in response to a termination condition to obtain the stored dialog in a final iteration of the iterating, wherein the stored dialog in the final iteration is the synthetic data; and
training a neural network, implemented by at least one second processor, based on the synthetic data.

2. The method of claim 1, wherein the training comprises performing a first learning by the neural network based on other data and performing a second learning by the neural network based on the synthetic data to refine the neural network.

3. The method of claim 2, wherein the other data is real data based on at least one real dialog.

4. The method of claim 1, wherein the synthetic data is text data.

5. The method of claim 1, wherein the synthetic data is audio data.

6. The method of claim 1, wherein at least one of the roles of the first speaker or the second speaker comprise characteristics of the first speaker or the second speaker.

7. The method of claim 6, wherein the characteristics comprise at least one of: name, gender, age, address or occupation.

8. A system for generating synthetic data for the training and/or testing of neural networks comprising:
at least one Large Language Model (LLM) module;
a data storing unit; and
a bot builder service module, implemented by at least one processor, configured to perform
defining of roles for a plurality of speakers,
inputting the roles to the at least one LLM module,
requesting the at least one LLM module to generate a first statement based on the role of a first speaker of the plurality of speakers,
instructing the at least one LLM module to generate a second statement based on the role of a second speaker of the plurality of speakers that is responsive to the first statement,
storing, in the data storing unit, of a dialog between the first speaker and the second speaker comprising the first and second statements,
iterating the requesting, instructing and storing such that
the first statement is responsive to the second statement of a preceding iteration of the requesting,
the second statement is responsive to the first statement of a current iteration of the requesting instructing and storing,
the storing comprises adding the first and second statements of a current iteration to the dialog such that the dialog comprises the first and second statements of each previous iteration of the requesting, instructing and storing, and
each instance of the requesting and instructing comprises providing the at least one LLM module with the dialog of a preceding iteration of the storing,
ceasing said iterating in response to a termination condition to obtain the stored dialog in a final iteration of the iterating, wherein the stored dialog in the final iteration is the synthetic data.

9. The system of claim 8, wherein the at least one LLM module provides each instance of the first and second statement as text data.

10. The system of claim 9, wherein the synthetic data is textual data.

11. The system of claim 9, wherein the dialog is modeled for implementation on a dialog channel that is a text-based platform.

12. The system of claim 9, further comprising:
a Text-to-Speech (TTS) Service module, implemented by the at least one processor, wherein the TTS Service module is configured to convert the text data to audio data; and
a voice cloning service module, implemented by the at least one processor, wherein the voice cloning service module is configured to clone at least one voice and convert the audio data into cloned audio data in the at least one voice such that the synthetic data is stored as the cloned audio data.

13. The system of claim 12, wherein the dialog is modeled for implementation on a dialog channel that is a voice-based platform.

14. The system of claim 12, wherein the dialog is modeled for implementation on a dialog channel that is both a textual-based platform and a voice-based platform.

15. The system of claim 8, wherein at least one of the roles of the first speaker or the second speaker comprises characteristics of the first speaker or the second speaker.

16. The system of claim 15, wherein the characteristics comprise at least one of: name, gender, age, address or occupation.

17. A method for refining a conversation analytics platform comprising:
generating synthetic data by
defining roles for a plurality of speakers,
inputting the roles to at least one Large Language Model (LLM), implemented by at least one first processor,
requesting the at least one LLM to generate a first statement based on the role of a first speaker of the plurality of speakers,
instructing the at least one LLM to generate a second statement based on the role of a second speaker of the plurality of speakers that is responsive to the first statement,
storing a dialog between the first speaker and the second speaker comprising the first and second statements,
iterating the requesting, instructing and storing such that
the first statement is responsive to the second statement of a preceding iteration of the requesting,
the second statement is responsive to the first statement of a current iteration of the requesting instructing and storing,
the storing comprises adding the first and second statements of a current iteration to the dialog such that the dialog comprises the first and second statements of each previous iteration of the requesting, instructing and storing, and
each instance of the requesting and instructing comprises providing the at least one LLM with the dialog of a preceding iteration of the storing,
ceasing said iterating in response to a termination condition to obtain the stored dialog in a final iteration of the iterating, wherein the stored dialog in the final iteration is the synthetic data;
inputting the synthetic data to the conversation analytics platform, which is implemented by at least one second processor;
receiving feature results characterizing the synthetic data from the conversation analytics platform;
comparing the feature results to initial parameters including the roles for the plurality of speakers to determine whether at least one model portion of the conversation analytics platform is deficient;
refining the at least one model portion of the conversation analytics platform in response to determining that the at least one model portion of the conversation analytics platform is deficient.

18. The method of claim 17, whether the synthetic data is first synthetic data and the method further comprises:
generating second synthetic data, wherein the refining comprises refining the at least one model portion of the conversation analytics platform with the second synthetic data.

19. The method of claim 18, wherein the second synthetic data is provided in a model training dataset and wherein the refining comprises training the at least one model portion with the model training dataset.

20. The method of claim 19, wherein the model training dataset comprises the first synthetic data.
